(19) United States
(12) Patent Application Publication
(10) Pub. No.: US 2008/0195740 A1
(43) Pub. Date: Aug. 14, 2008

(54) Maintaining session state information in a client server system

(75) Inventors: David E. Lowell, San Francisco, CA (US); James Roseborough, Piedmont, CA (US); Gavin Peacock, Walnut Creek, CA (US)

Correspondence Address: BEYER WEAVER LLP, P.O. BOX 70250, OAKLAND, CA, 94612-0250, US

(73) Assignee: MobiTV, Inc.

(21) Appl. No.: 11/706,141

(22) Filed: Feb. 12, 2007

(51) Int. Cl. G06F 15/16

(52) U.S. Cl. 709/229

(57) ABSTRACT

Techniques and mechanisms are provided for maintaining session state information in a client server system. Session state information such as session state, time stamp information, activity state, counters, etc. are generated and updated by a server. The session state information is sent in encrypted form to a client and the client maintains the encrypted information. The client is not able to decipher or alter the encrypted information. The client sends the encrypted session state information in requests to the server. The server is able to respond intelligently using session state information from the client. Session state information no longer has to be maintained or replicated by session state managers associated with servers.

### TECHNICAL FIELD

The present disclosure relates to maintaining session state information in a client server system.

### DESCRIPTION OF RELATED ART

In client server systems, it is often useful to maintain state information associated with client server interaction. For example, it may be useful for a server to know what functions a client is authorized to perform, or what operations a client has already performed. When the client makes a request to the server, the session information allows the server to intelligently respond to the request in an efficient manner.

However, mechanisms for maintaining session state information have significant limitations. Consequently, it is desirable to provide improved techniques and mechanisms for maintaining session state.

### BRIEF DESCRIPTION OF THE DRAWINGS

The disclosure may best be understood by reference to the following description taken in conjunction with the accompanying drawings, which illustrate particular example embodiments.

FIG. 1 illustrates a particular example of a client server system.

FIG. 2 illustrates a particular example of session state information.

FIG. 3 illustrates a particular example of an exchange between a server and a client.

FIG. 4 illustrates a particular example of an exchange between a server and a client.

FIG. 5 illustrates a particular example of an exchange between a server and a client.

FIG. 6 illustrates a technique for maintaining session state information.

FIG. 7 illustrates a particular example of a server.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of particular client server systems, cryptographic mechanisms, and networks. However, it should be noted that the techniques of the present invention apply to a client server systems, cryptographic mechanisms, and a variety of different networks. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors can while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

### Overview

Techniques and mechanisms are provided for maintaining session state information in a client server system. Session state information such as session state, time stamp information, activity state, counters, etc. are generated and updated by a server. The session state information is sent in encrypted form to a client and the client maintains the encrypted information. The client is not able to decipher or alter the encrypted information. The client sends the encrypted session state information in requests to the server. The server is able to respond intelligently using session state information from the client. Session state information no longer has to be maintained or replicated by session state managers associated with servers.

### Claim Overview

According to various embodiments, first session state information associated with a first session is between a server and a first client is encrypted. The first session state information is encrypted using a server key. The first session state information is sent to the first client and the first client maintains the first session state information. Second session state information associated with a second session between the server and a second client is also encrypted. The second session state information for the second session is encrypted using the server key. The second session state information for the second session is sent to the second client and the second client maintains the session state information.

### Example Embodiments

Session state information allows a server interacting with a client to be able to vary responses and client access depending not only on the particular request but on the state of the interaction. For example, a client may initially have little access to a set of operations. However, after the client is authenticated and authorized, the server may allow the client to subsequently access a variety of operations for a period of time. Some clients may access a wider range of operations based on the level of authorization. In some examples, after a time period has expired, authorization expires. In many instances, sessions are secured using shared keys that are generated by both the client and the server. The client and the server exchange information that allows generation of shared keys using a variety of key exchange protocols to provide a secure session.

Session state information is generally stored in a server using a mechanism such as session state manager. When a client starts a session, the server provides the client with a new session identifier (session ID). Whenever the client transmits data to the server, the client includes the session ID. The server determines the session state information for that session using the session state manager with the session ID as a key. The session state information provides a variety of information about a client, such as authorization level, request count, session activity level, timeout periods, etc.

Although mechanisms such as session state managers are popular and widely used, conventional mechanisms have a variety of limitations. In some examples, a session state manager is a single point of failure. If a session state manager fails, a client will not be able to receive service. Consequently, session state managers are often not only replicated, but replicated with state information. Replication or mirroring with state information increases the complexity of providing redundancy. Session state managers are also a bottleneck preventing an increase in the number of client interactions. The session state typically has to be determined on every request from the client based on the session ID. To provide reliability and scalability, the session state manager is typically structured as a replicated service, with session state held by multiple session state manager nodes. Structuring the system in this way increases cost and adds complexity. Session data has to be consistent between session state manager nodes in the presence of software and hardware failures, widely varying loads, and node addition and removal.

Consequently, various embodiments of the present invention allow for the secure maintenance of session state information on a client device. Servers and session state managers are no longer a single point of failure, as a variety of other servers can take over operation in the event of failure. A session state manager does not have to be mirrored with state information. According to various embodiments, session state information is stored at the client in an encrypted or opaque string. The client does not need to interpret the string and in many instances should not be able to interpret the string, as the encrypted state information in the string is intended only for server consumption. The client is configured to provide the session state information in the form of an encrypted string to the server when it makes requests. In particular embodiments, the client is also configured to update its saved copy of the encrypted session state information string whenever the server includes new session state information or a new session data string in a response message.

To provide that the server alone can create, update, change or delete session data, the server can encrypt the session data string before sending it to the client. During the encryption, it uses a secret key known only to the server. According to various embodiments, the server key is used for multiple client and multiple sessions and is shared with a replicated server. If the client (or someone impersonating the client) attempts to tamper with the session data, the server will be unable to decrypt the string and refuse to process the request from the client. In particular embodiments, the server can use any strong cipher for encrypting the session data. Because only the server has to decrypt the session data string, it is free to change the encryption key or the cipher as needed. When the client starts a session, the server can assign a new session ID and initialize a new session state string for the client. That state string can include a flag to indicate that the client has not yet authorized its session.

Once the client has authorized its session, the server can update the authorization flag in the session state to indicate that the client's session is authorized. Because the session data is encrypted using a secret key known only to the server, the server is free to store this critical authorization flag in the session data. Malicious, unauthorized users with their own client will not be able to manipulate the session data string to spoof the server into thinking that a malicious client's session is authorized. Although this encryption will prevent tampering with the session data, the service may still be vulnerable to some forms of replay attacks in which the session data string from an authorized session is copied verbatim to an unauthorized user's session to allow access. To address replay attacks, the server can embed other information such as counters and hardware identifiers in the session data string. For example, the server could accept a session data string for only a very limited period of time.

In particular embodiments, a server could enforce that time limit by storing a timestamp of when the session was authorized in the session data string. Because the session data string is encrypted, no one but the server will be able to alter that timestamp to extend a session. The server may also store other authentication-related tokens, such as the client's IP address, user ID, and so on. In particular embodiments, a server stores hardware identifiers associated with a mobile device in the session data string. According to various embodiments, the server can check that all requests for a given session come from the same IP address, user ID, mobile device, etc.

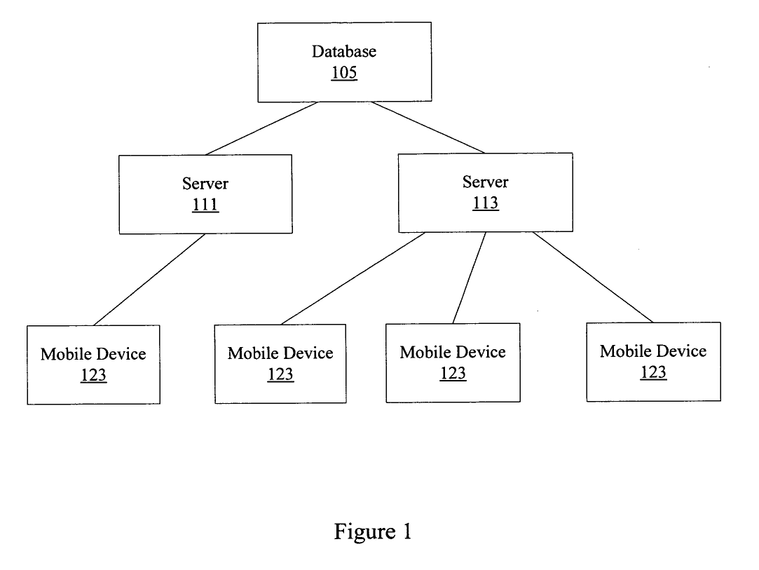

FIG. 1 illustrates one particular example of a network that can use the techniques and mechanisms of the present invention. The network includes servers 111 and 113 connected to mobile devices 121, 123, 125, and 127. The servers 111 and 113 are also associated with a database 105. According to various embodiments, a mobile device 121 sends requests to a server 111. The server 111 determines the state of any session with the mobile device 121 by accessing information stored at server 111. In some instances, no session has been started. In other instances, a session may have already been started and some state information may already be available.

The server 111 may access database 105 to determine whether to authorize a mobile device 123 for particular operations. In particular embodiments, a server 111 begins a key exchange sequence with a mobile device 123 to start a session and uses a shared key to encrypt all communications during the session. The server 111 may periodically update session state information stored at the server 111. For example, the server 111 may have to update state information to reflect a session timeout. When state information is updated, the mobile device 123 may no longer have the same access privileges and may no longer be able to perform the same operations.

To scale a system and also to provide reliability, a server 113 may operate as a backup to server 111. According to various embodiments, a connection between server 111 and server 113 allows mirroring of state information associated with various client server sessions. However, having a server 111 associated with a server session manager maintain information about session states can often be inefficient, prevent scaling, and increase mirroring complexity. The session state manager is typically structured as a replicated service, with session state held by multiple session state manager nodes. Consistent session data has to be maintained across multiple session state manager nodes in the presence of software and hardware failures, widely varying loads, and node addition and removal.

Consequently, the techniques of the present invention contemplate maintaining session information at a client device. According to various embodiments, the session information or session state information is maintained as an encrypted, opaque string on a client device on a mobile device. A mobile device is not able to tamper or decipher the string. Instead, the string is provided to the server during client server requests. The server obtains state information associated with a client request by decrypting the session information from the client. According to various embodiments, no session information is maintained at any server. No stateful replication is required for session information. No key generation is required. In particular embodiments, a server simply uses the same key for session information strings from multiple clients.

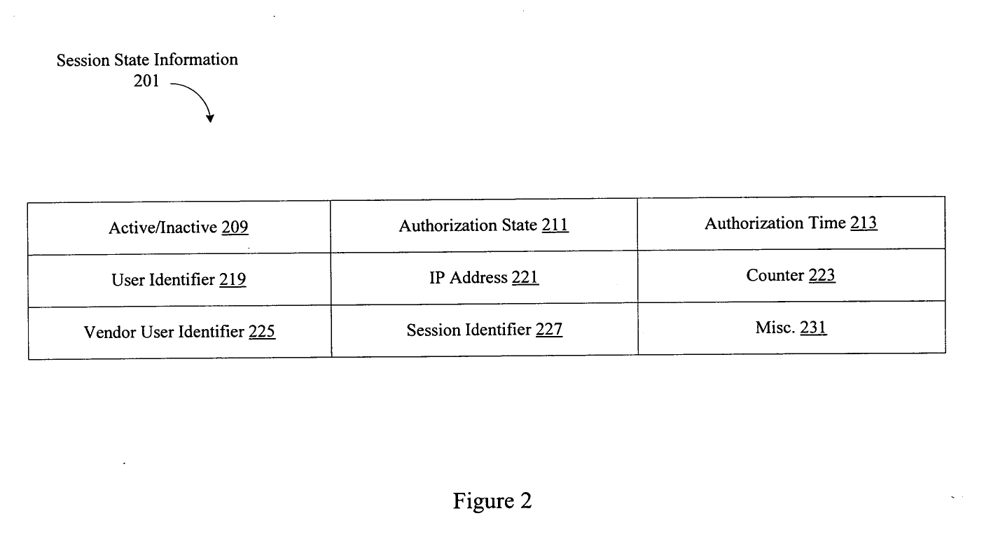

FIG. 2 illustrates an example of session state information. According to various embodiments, session state information is maintained at a client device or a peripheral easily accessible by the client device. Session state information 201 includes an active/inactive indicator 209 and an authorization state 211. These fields may also be used to show various authorization and activity levels. Session state information 201 also includes identifiers such as user identifier 219, IP address 221, vendor user identifier 225, and session identifier 227. In particular embodiments, user identifier 219 is an application instance identifier. When a user installs a client application, a new ID is generated to identify that client application instance. The IP address 221 is associated with the client source address. According to various embodiments, the vendor user identifier (VUID) 225 is a hardware ID or carrier-assigned user identifier. The VUID is typically tied to a client mobile device, handset, or subscriber identity module (SIM) card.

In some embodiments, the VUID is obtained from a special HTTP header inserted into client requests by the carrier's HTTP proxy. In other deployments, the vending process may insert the VUID into a file of the vended application. There are a variety of ways to pick up a VUID. When a server creates an account for a particular user ID, it associates that account with the VUID. In particular embodiments, one VUID can be associated with multiple active user IDs. In some examples, a client device will have multiple applications accessing a server. According to various embodiments, there will be one user ID for both client applications, and each of those user IDs will be associated with the same VUID. A session identifier 227 is created to identify a particular session. Providing various identifiers in encrypted form in a session state string provides additional security, particularly since a user identifier can be associated with a particular physical device. Even if a snooper were able to obtain the session state string, the session state string could not be used with a different device with a different VUID.

The session state information 201 also includes authorization time 213 and counter 223 to provide information about when authorization should expire and the number of requests during a particular session. Miscellaneous information 231 can also be provided. According to various embodiments, any information used or accessed by a session state manager and conventionally stored at a server can be included in a session information string and stored on a client device. In some examples, applications at a client include a video and an audio application. A human-readable, dash-separated identifier can also be include in a session state string. The identifier can be used to look up user records in a database. In particular embodiments, the customer is associated in the database with the VUID. As such, the same customer number applies to all video and audio accounts created using a single device or SIM card.

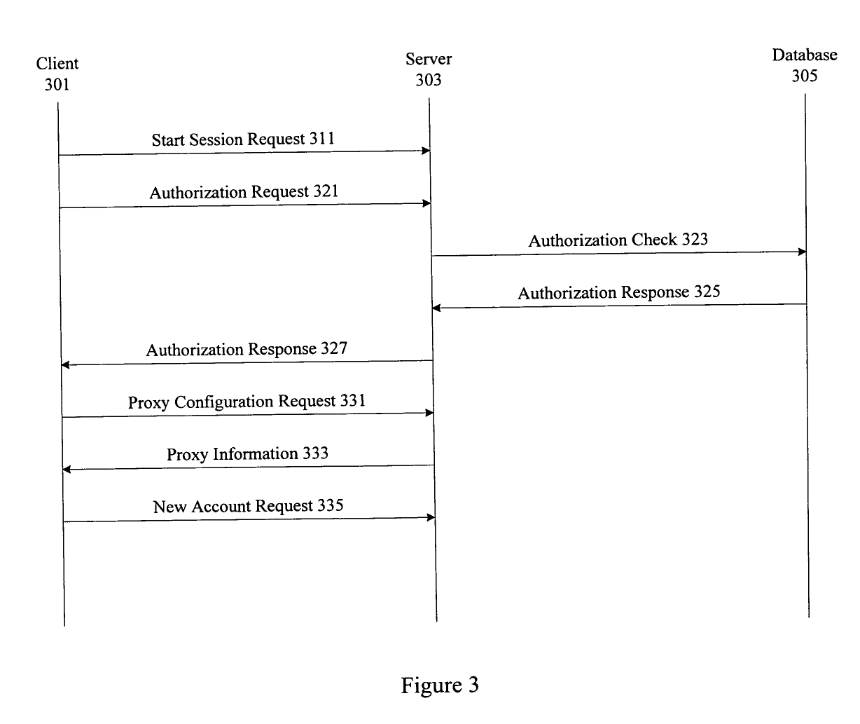

FIG. 3 illustrates one particular example of a client server interaction. According to various embodiments, a system includes a client 301, a server 303, and a database 305. According to various embodiments, a client 301 sends a start session request 311 to a server 303. In particular embodiments, a client associated application makes a start session request 311 to start a new user session. The request 311 establishes a session in the unauthorized state and assigns a session ID for the session. According to various embodiments, it creates a new session data string or session state data information structure to hold the state of the session. In particular embodiments, the session data initially notes that the session is active, but not authorized. In an unauthorized session, the client is only allowed to make a subset of requests. According to various embodiments, a server 303 may or may not send a start session response back the client 301. In particular embodiments, the start session response simply tells the client their new session ID and provides the new session data. The client 301 proceeds to send the session data or session state information in subsequent requests.

According to various embodiments, the client 301 makes an authorization request to convert the session from the unauthorized state to the authorized state, to allow the client to make a variety of requests. In particular embodiments, the authorization request can allow a client to receive permission to make a variety of server requests. The authorization request may include particular client identifiers.

According to various embodiments, to process an authorization request 321, the server 303 processes the VUID for the user. The server 303 makes an authorization check 323 to database 305 to determine if the client 301 should be authorized to receive particular services. The database 305 responds with an authorization response 325. For clients with an established user ID and VUID, the server 303 can use the user ID present in the request 321 to look up the VUID in the database. According to various embodiments, the server 303 gets the VUID for the client from all available sources and compares them. If the client 301 is authorized, the server 303 returns an authorization response 327 to the client that sets the status to authorized. In particular embodiments, the server 303 updates session state information or session data in the response 327 to reflect the authorized status and provides a timestamp indicating when authorization will expire. According to various embodiments, to help prevent certain types of replay attacks, the server 303 also saves the user ID, VUID, and session ID of the authorized session in the session data provided in authorization response 327.

According to various embodiments, the client 301 also sends a proxy configuration request 331. The proxy configuration request 331 allows the client to request updated hostname, port, or credentials for the carrier's proxy. In particular embodiments, the client 301 batches a proxy configuration request 331 with each authorization request 321. The server 303 responds with proxy information 333. An uninitialized client can also a new account request 335 to initialize a new account and obtain a user ID. In particular embodiments, the server 303 uses the VUID to initialize a new account.

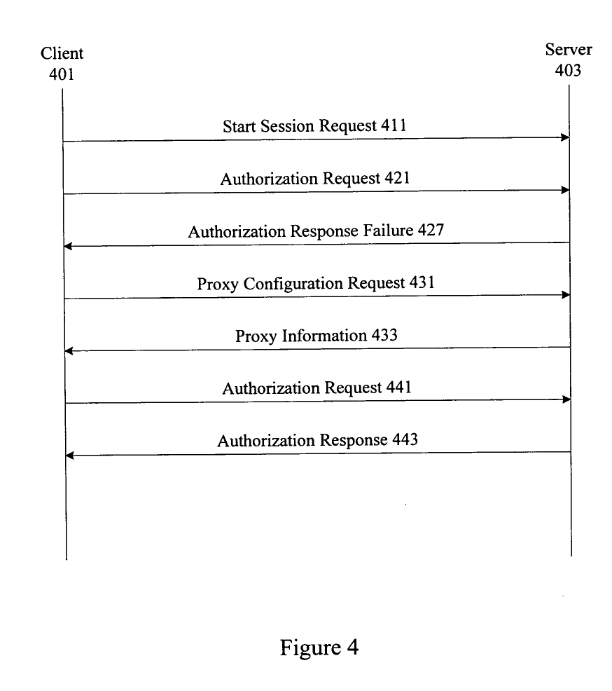

FIG. 4 illustrates one example of a client server interaction with an authorization response failure. According to various embodiments, a system includes a client 401 and a server 403. A client 401 sends a start session request 411 to a server 403. In particular embodiments, a client associated application makes a start session request 411 to start a new user session. The request 411 establishes a session in the unauthorized state and assigns a session ID for the session. According to various embodiments, it creates a new session data string or session state data information structure to hold the state of the session. In particular embodiments, the session data initially notes that the session is active, but not authorized. In an unauthorized session, the client is only allowed to make a subset of requests. According to various embodiments, a server 403 may or may not send a start session response back the client 401. In particular embodiments, the start session response simply tells the client their new session ID and provides the new session data. The client 401 proceeds to send the session data or session state information in subsequent requests.

According to various embodiments, the client 401 makes an authorization request to convert the session from the unauthorized state to the authorized state, to allow the client to make a variety of requests. In particular embodiments, the authorization request can allow a client to receive permission to make a variety of server requests. The authorization request may include particular client identifiers.

According to various embodiments, to process an authorization request 421, the server 403 processes the VUID for the user. In particular embodiments, the server can refuse to authorize a user's session for a variety of reasons. For example, if a VID or user ID are not found in a database associated with the server, the server 403 will return an exception to the client and keep the user's session in the “not authorized” state. If the authorization URL does not return “AUTH 1∞, server 403 returns an authorization response failure 427 with a not authorized status.

Server 403 may have a configurable policy for handling the case of an un-initialized client that attempts to authorize but fails to pass a VUID in the authorization request 411, and fails to pick up a VUID in the HTTP request headers. In particular embodiments, the server will send an authorization response with status proxy failure to the client 401. According to various embodiments, to minimize the likelihood of legitimate customers being prevented from initializing their new clients because of a temporary problem, the server 403 can be configured to provide provisional access.

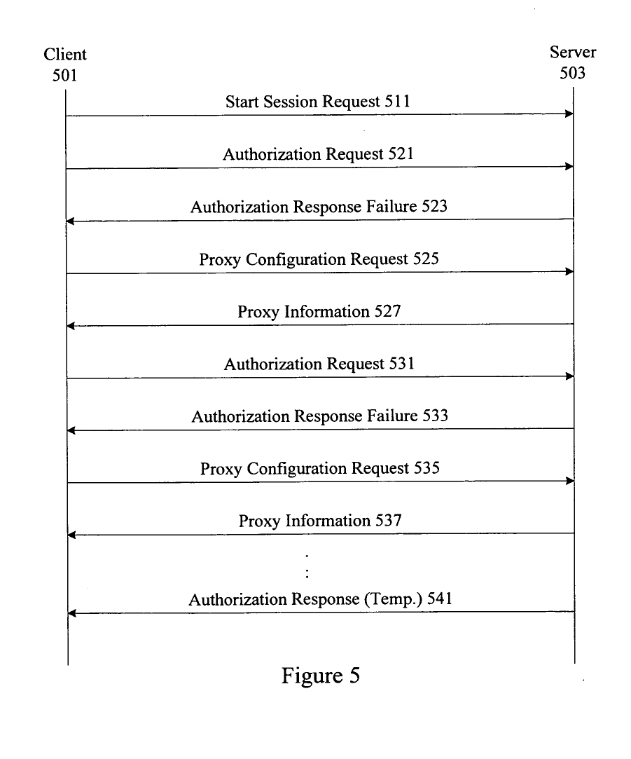

FIG. 5 illustrates another example of client server interaction. According to various embodiments, a system includes a client 501 and a server 503. According to various embodiments, a client 501 sends a start session request 511 to a server 503. In particular embodiments, a client associated application makes a start session request 511 to start a new user session. The request 511 establishes a session in the unauthorized state and assigns a session ID for the session. According to various embodiments, a server 503 may or may not send a start session response back the client 501. In particular embodiments, the start session response simply tells the client their new session ID and provides the new session data. The client 501 proceeds to send the session data or session state information in subsequent requests.

According to various embodiments, the client 501 makes an authorization request to convert the session from the unauthorized state to the authorized state, to allow the client to make a variety of requests. According to various embodiments, to process an authorization request 521, the server 503 processes the VUID for the user. In particular embodiments, the server can refuse to authorize a user's session for a variety of reasons. Server 503 may have a configurable policy for handling the case of an un-initialized client that attempts to authorize but fails to pass a VUID in the authorization request 511, and fails to pick up a VUID in the HTTP request headers. In particular embodiments, the server will send an authorization response with status proxy failure to indicate to the client that the server 503. According to various embodiments, to minimize the likelihood of legitimate customers being prevented from initializing their new clients because of a temporary problem, the server 503 can be configured to provide provisional access.

In particular embodiments, if after repeated attempts including requests and responses 523, 525, 527, 531, 533, 535, and 537, the initializing client has failed to make an authorization request with VUID inserted into HTTP request headers, the server 503 can grant the user a “temporary” account. The server 503 returns an authorization response 541 to the client with status authorized, and another flag in the session data to indicate to a subsequent new account request that although the client 501 has not been properly authorized, the client 501 should receive a temporary account.

According to various embodiments, a client 501 with a temporary account has up to five sessions to get a valid VUID from the carrier's proxy. In each of those sessions, the client will make an authorization request via the carrier's proxy like usual. As soon as the server receives an authorization request with the user's VUID in the headers or request attributes, it will upgrade the user's account from temporary to permanent and store their VUID in the database and make updates to session data stored at a client. If after five sessions the user has still not provided a valid VUID, a server will deny that client further access.

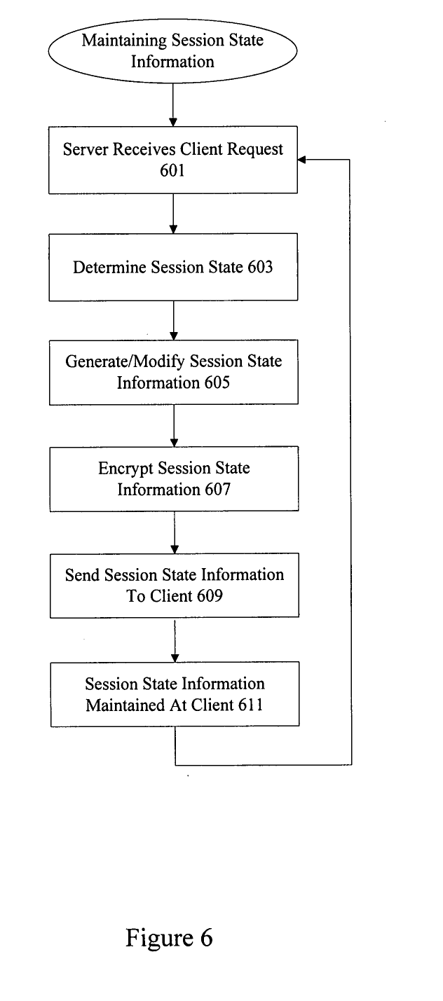

FIG. 6 is illustrates one example of maintaining session state information. At 601, a server receives a client request. According to various embodiments, the server receives an authorization request or some other data request from a client. The server determines session state for a session associated with the client at 603. In particular embodiments, the server obtains session state information or a session data string from a client. The session state information from a client is decrypted in order to determine authorization level or activity level. The server updates session state information at 605. In some instances, there may be no session data string or session state information, so a server creates session state information. In particular embodiments, the session state information indicates that a session is active but not authorized. At 607, the server encrypt session state information using a server key.

According to various embodiments, the server encrypts session state information for multiple client using the same session key. By using the same key, resource intensive key exchange protocols no longer have to be used. In particular embodiments, the key is shared with several servers and changed periodically. At 607, session state information is sent to the client 607. According to various embodiments, all session state information is sent in encrypted form. At 611, session state information is maintained at the client. No session state information needs to be maintained by the server. In some examples, a server can store hash of the session state information send and compare a hash of any session state information returned by a client to further verify authenticity. In many particular examples, however, no state information needs to maintained or mirrored by any server, as the client is configured to provide the session state information on any request.

A variety of devices and applications can use particular examples of the present invention. Various clients, servers, computer systems, mobile devices, mobile phones, can all be used for allowing stateless servers. In some examples, servers are completely stateless. In other examples, servers have some state information and clients maintain other state information. In still other examples, servers may have some state information but the clients maintain state information needed for continued operation in the event that a server fails.

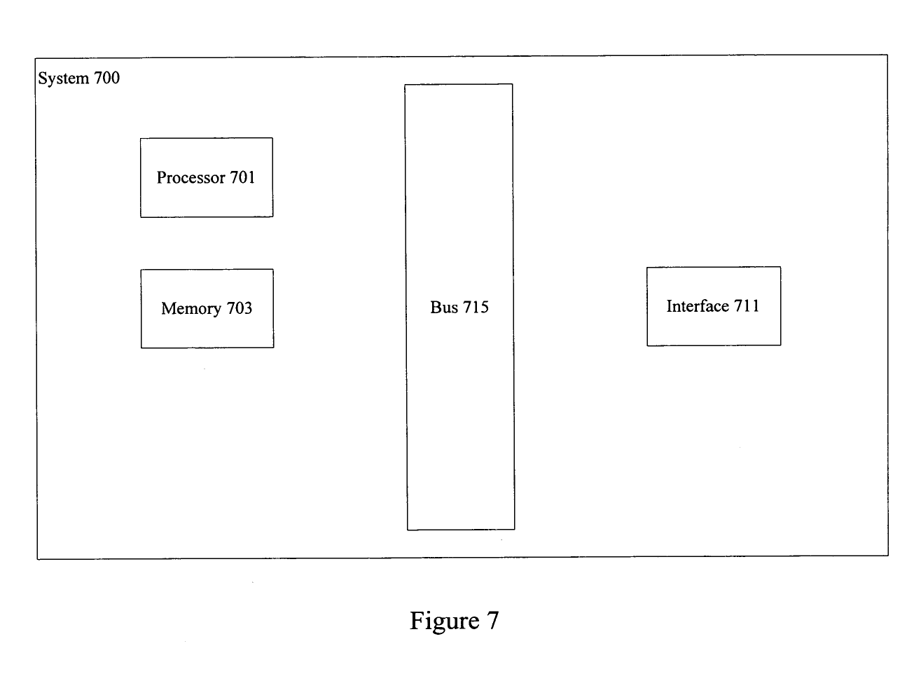

FIG. 7 illustrates one example of a server that send encrypted session state information to a client. According to particular example embodiments, a system 700 suitable for implementing particular embodiments of the present invention includes a processor 701, a memory 703, an interface 711, and a bus 715 (e.g., a PCI bus or other interconnection fabric). When acting under the control of appropriate software or firmware, the processor 701 is responsible for such tasks such as updating session state information or encrypting session state information for transmission to a client. Various specially configured devices can also be used in place of a processor 701 or in addition to processor 701. The interface 711 is typically configured to end and receive data packets or data segments over a network. Particular examples of interfaces supports include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 700 uses memory 703 to store data and program instructions. The program instructions may control the operation of an operating system and/or one or more applications.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
encrypting first session state information associated with a first session between a server and a first client, the first session state information encrypted using a server key;
sending the first session state information to the first client, wherein the first client maintains the first session state information;
encrypting second session state information associated with a second session between the server and a second client, the second session state information for the second session encrypted using the server key;
sending the second session state information for the second session to the second client, wherein the second client maintains the session state information.

2. The method of claim 1, wherein first session state information includes an authorized party identifier, a session length, a user identifier, an active/inactive state flag, and a counter.

3. The method of claim 1, wherein the first client is a first mobile phone.

4. The method of claim 3, wherein the first session state information is generated using a first mobile identifier associated with a subscriber identity module (SIM) card for the first mobile phone.

5. The method of claim 3, wherein the first session state information is generated using a first mobile identifier associated with a subscriber identity module (SIM) card for the first mobile phone.

6. The method of claim 1, wherein the server is a stateless server.

7. The method of claim 6, wherein no first session state information or second session state information is maintained at the stateless server.

8. The method of claim 1, wherein the same server key is used to encrypt session state information for a plurality of sessions associated with a plurality of clients.

9. The method of claim 1, wherein the first session state information is sent as a first encrypted string.

10. The method of claim 1, wherein the first encrypted string expires after a predetermined period of time.

11. A server, comprising:
a processor operable to encrypt first session state information associated with a first session between the server and a first client and to encrypt second session state information associated with a second session between the server and a second client, the first session state information and the second session state information encrypted using a key;
an interface operable to send the first session state information to the first client and to send the second session state information for the second session to the second client, wherein the first client maintains the first session state information and the second client maintains the second session state information.

12. The server of claim 11, wherein first session state information includes an authorized party identifier, a session length, a user identifier, an active/inactive state flag, and a counter.

13. The server of claim 11, wherein the first client is a first mobile phone.

14. The server of claim 13, wherein the first session state information is generated using a first mobile identifier associated with a subscriber identity module (SIM) card for the first mobile phone.

15. The server of claim 13, wherein the first session state information is generated using a first mobile identifier associated with a subscriber identity module (SIM) card for the first mobile phone.

16. The server of claim 11, wherein the server is a stateless server.

17. The server of claim 16, wherein no first session state information or second session state information is maintained at the stateless server.

18. The server of claim 11, wherein the same server key is used to encrypt session state information for a plurality of sessions associated with a plurality of clients.

19. The server of claim 11, wherein the first session state information is sent as a first encrypted string.

20. A system, comprising:
means for encrypting first session state information associated with a first session between a server and a first client, the first session state information encrypted using a server key;
means for sending the first session state information to the first client, wherein the first client maintains the first session state information;
means for encrypting second session state information associated with a second session between the server and a second client, the second session state information for the second session encrypted using the server key;
means for sending the second session state information for the second session to the second client, wherein the second client maintains the session state information.
